(19) United States
(12) Patent Application Publication
(10) Pub. No.: US 2025/0166125 A1
(43) Pub. Date: May 22, 2025

(54) METHOD OF GENERATING IMAGE AND ELECTRONIC DEVICE FOR PERFORMING THE SAME

(71) Applicants: Xiao TANG, Xi'an (CN); Min YANG, Xi'an (CN); Penghui SUN, Xi'an (CN); Hojae LEE, Xi'an (CN); Feng ZHU, Xi'an (CN)

(72) Inventors: Xiao TANG, Xi'an (CN); Min YANG, Xi'an (CN); Penghui SUN, Xi'an (CN); Hojae LEE, Xi'an (CN); Feng ZHU, Xi'an (CN)

(21) Appl. No.: 18/949,525

(22) Filed: Nov. 15, 2024

(30) Foreign Application Priority Data
Nov. 17, 2023 (CN) 202311544966.7
Aug. 27, 2024 (KR) 10-2024-0114849

(51) Int. Cl. G06T 3/4046; G06T 7/73

(52) U.S. Cl. CPC G06T 3/4046; G06T 7/73

(57) ABSTRACT

A method of generating an image includes obtaining an image sequence of a target scene and information about a first viewing angle, generating a plurality of rays corresponding to a plurality of pixels of an image plane of the first viewing angle of the target scene, determining a plurality of spatial points by sampling the plurality of rays, generating a first rendered image of the image plane by rendering the plurality of spatial points using a first neural network, determining a reference image of the first rendered image from among a plurality of images of the image sequence, and generating a second rendered image having a second resolution by upsampling the first rendered image using a second neural network and based on the reference image. The plurality of images being captured from the first viewing angle and having a first resolution, and the first rendered image having the first resolution.

### CROSS-REFERENCE TO RELATED APPLICATIONS

This application claims priority under 35 U.S.C. § 119 to Chinese Patent Application No. 202311544966.7, filed on Nov. 17, 2023, in the China National Intellectual Property Administration, and to Korean Patent Application No. 10-2024-0114849, filed on Aug. 27, 2024, in the Korean Intellectual Property Office, the disclosures of which are incorporated by reference herein in their entireties.

### BACKGROUND

### 1. Field

The present disclosure relates generally to image processing, and more particularly, to a method of generating an image related to image rendering, a method of updating an image generation model, and an electronic device for performing the same.

### 2. Description of Related Art

When testing technologies such as, but not limited to, autonomous driving, autonomous flight, or the like, simulators may be used to simulate various situations and/or scenarios as reproducing such situations and/or scenarios may be difficult on real environments (e.g., actual roads). Although various open source simulator technologies may have been developed for performing these tests, the simulators may not be able to fully simulate the real environments, and as such, there may be differences between virtual and real environments. Consequently, the test results may not match well with the real environments. In addition, generating three-dimensional (3D) objects for the simulators may incur a significant cost and/or time investment.

Recent advances in neural rendering technology may enable more realistic autonomous driving tests by reconstructing road environments and 3D objects based on actually measured data, for example. However, data collected while a vehicle is still moving at a significant speed may only provide data of a specific object and/or scene from a limited angle. As a result, a quality of a new image of the scene generated from a new angle rather than the known angle may be reduced (e.g., may have a poor quality). Consequently, reconstruction of large dynamic scenes may be difficult.

### SUMMARY

One or more example embodiments may address at least the above problems and/or disadvantages and other disadvantages not described above. Also, the example embodiments are not required to overcome the disadvantages described above, and an example embodiment may not overcome any of the problems described above.

According to an aspect of the present disclosure, a method of generating an image, performed by an electronic device, includes obtaining an image sequence of a target scene and information about a first viewing angle, generating a plurality of rays corresponding to a plurality of pixels of an image plane of the first viewing angle of the target scene, determining a plurality of spatial points by sampling the plurality of rays, generating a first rendered image of the image plane by rendering the plurality of spatial points using a first neural network, determining a reference image of the first rendered image from among a plurality of images of the image sequence, and generating a second rendered image having a second resolution by upsampling the first rendered image using a second neural network and based on the reference image. The plurality of images of the image sequence being captured from the first viewing angle and having a first resolution. The first rendered image have the first resolution.

In some embodiments, the obtaining of the image sequence of the target scene and the information about the first viewing angle may include obtaining the image sequence by downsampling an original image of the target scene.

In some embodiments, the determining of the reference image may include generating optical flow information of the target scene, and determining, based on the optical flow information, the reference image from among the plurality of images of the image sequence.

In some embodiments, the determining of the reference image may further include determining a first previous image from among one or more previous images of the first rendered image, based on forward optical flow information of the optical flow information, determining a first following image from among one or more following images of the first rendered image, based on backward optical flow information of the optical flow information, and determining at least one of the first previous image or the first following image as the reference image.

In some embodiments, the determining of the at least one of the first previous image or the first following image as the reference image may include determining at least one similar region from the at least one of the first previous image or the first following image, and determining the at least one of the first previous image or the first following image as the reference image based on performing a sliding window on the at least one similar region.

In some embodiments, the generating of the second rendered image may include generating a first feature by extracting a first plurality of features from the first rendered image, generating a second feature by extracting a second plurality of features from the reference image, generating a third feature by fusing the first feature and the second feature, generating a fourth feature by performing cascading residual processing on the third feature, and generating the second rendered image by decoding the fourth feature.

In some embodiments, the method of generating the image may include updating the first neural network based on neural radiance fields (NeRF).

According to an aspect of the present disclosure, a non-transitory computer-readable storage medium storing instructions that, when executed by a processor, cause the processor to perform the method of generating the image as described above.

According to an aspect of the present disclosure, an electronic device includes at least one processor, and a memory storing instructions. The instructions are configured to, when individually or collectively executed by the at least one processor, cause the electronic device to obtain an image sequence of a target scene and information about a first viewing angle, generate a plurality of rays corresponding to a plurality of pixels of an image plane of the first viewing angle of the target scene, determine a plurality of spatial points by sampling the plurality of rays, generate a first rendered image of the image plane by rendering the plurality of spatial points using a first neural network, determine a reference image of the first rendered image from among a plurality of images of the image sequence, and generate a second rendered image having a second resolution by upsampling the first rendered image using a second neural network and based on the reference image. The plurality of images of the image sequence being captured from the first viewing angle and having a first resolution. The first rendered image has the first resolution.

In some embodiments, the instructions may be configured to, when individually or collectively executed by the at least one processor, further cause the electronic device to obtain the image sequence by downsampling an original image of the target scene.

In some embodiments, the instructions may be configured to, when individually or collectively executed by the at least one processor, further cause the electronic device to generate optical flow information of the target scene, and determine, based on the optical flow information, the reference image from among the plurality of images of the image sequence.

In some embodiments, the instructions may be configured to, when individually or collectively executed by the at least one processor, further cause the electronic device to determine a first previous image from among one or more previous images of the first rendered image, based on forward optical flow information of the optical flow information, determine a first following image from among one or more following images of the first rendered image, based on backward optical flow information of the optical flow information, and determine at least one of the first previous image or the first following image as the reference image.

In some embodiments, the instructions may be configured to, when individually or collectively executed by the at least one processor, further cause the electronic device to determine at least one similar region from the at least one of the first previous image or the first following image, and determine the at least one of the first previous image or the first following image as the reference image based on performing a sliding window on the at least one similar region.

In some embodiments, the instructions may be configured to, when individually or collectively executed by the at least one processor, further cause the electronic device to generate a first feature by extracting a first plurality of features from the first rendered image, generate a second feature by extracting a second plurality of features from the reference image, generate a third feature by fusing the first feature and the second feature, generate a fourth feature by performing cascading residual processing on the third feature, and generate the second rendered image by decoding the fourth feature.

In some embodiments, the instructions may be configured to, when individually or collectively executed by the at least one processor, further cause the electronic device to update the first neural network based on NeRF.

According to an aspect of the present disclosure, a method of updating an image generation model, performed by an electronic device, includes obtaining an image sequence of a target scene, generating, for a first image of the image sequence, a plurality of rays corresponding to a plurality of pixels of an image plane of a first viewing angle of the target scene, determining a plurality of spatial points by sampling the plurality of rays, generating a first rendered image of the image plane by rendering the plurality of spatial points using a first neural network of the image generation model, determining a reference image of at least one of the first image or the first rendered image, generating a second rendered image having a second resolution by upsampling the first rendered image based on the reference image using a second neural network of the image generation model, and updating the image generation model based on the second rendered image and the first image. The image sequence includes a plurality of images captured from the first viewing angle and having a first resolution. The first rendered image having the first resolution.

In some embodiments, the determining of the plurality of spatial points may include determining the plurality of spatial points corresponding to a predetermined shape by sampling the plurality of rays according to the predetermined shape.

In some embodiments, the determining of the reference image may include generating optical flow information of the target scene, and determining, based on the optical flow information, the reference image from among the plurality of images of the image sequence.

In some embodiments, the generating of the second rendered image may include generating the second rendered image by performing at least one of feature extraction, feature fusion, cascading residual processing, or feature decoding on the first rendered image and the reference image.

According to an aspect of the present disclosure, a non-transitory computer-readable storage medium storing instructions that, when executed by a processor, cause the processor to perform the method of updating an image generation model as described above.

Additional aspects may be set forth in part in the description which follows and, in part, may be apparent from the description, and/or may be learned by practice of the present disclosure.

### BRIEF DESCRIPTION OF THE DRAWINGS

The above and/or other aspects, features, and advantages of certain embodiments of the present disclosure may be more apparent from the following description taken in conjunction with the accompanying drawings, in which:

FIG. 1 is a flowchart of a method of updating an image generation model, according to an embodiment;

FIG. 2 is a flowchart illustrating a method of updating an image generation model, according to an embodiment;

FIG. 3 is a flowchart of a method of generating an image, according to an embodiment;

FIG. 4 is a flowchart illustrating a method of generating an image, according to an embodiment;

FIG. 5 is a flowchart illustrating a method of determining a reference image in a training operation, according to an embodiment;

FIG. 6 is a flowchart illustrating a method of determining a reference image in an inference operation, according to an embodiment;

FIG. 7 is a flowchart illustrating a method of using a reference convolutional neural network (CNN) decoder module, according to an embodiment;

FIG. 8 illustrates a cascading residual processing unit, according to an embodiment;

FIG. 9 illustrates a cascading block, according to an embodiment;

FIG. 10 illustrates a residual block, according to an embodiment;

FIG. 11 illustrates a basic block, according to an embodiment;

FIG. 12 illustrates an electronic device for performing a method of generating an image, according to an embodiment;

FIG. 13 illustrates an electronic device for performing a method of updating an image generation model, according to an embodiment; and

FIG. 14 illustrates a structure of an electronic device, according to an embodiment.

### DETAILED DESCRIPTION

Hereinafter, various embodiments of the present disclosure are described with reference to the accompanying drawings. However, various alterations and modifications may be made to the embodiments and thus, the scope of the present disclosure is not limited or restricted to the embodiments. The equivalents are to be understood to include all changes, equivalents, and/or replacements within the idea and the technical scope of the present disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It is to be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It is to be further understood that terms, such as those defined in commonly-used dictionaries, should be interpreted as having a meaning that is consistent with their meaning in the context of the relevant art and are not to be interpreted in an idealized or overly formal sense unless expressly so defined herein.

When describing the embodiments with reference to the accompanying drawings, like reference numerals may refer to like components and a repeated description related thereto may be omitted for the sake of brevity. In the description of embodiments, detailed description of well-known related structures or functions may be omitted when such a description may cause ambiguous interpretation of the present disclosure.

In addition, the terms first, second, A, B, (a), and (b) may be used to describe constituent elements of the embodiments. These terms may be used only for the purpose of discriminating one component from another component, and the nature, the sequences, or the orders of the components may not be limited by the terms. It should be noted that if it is described that one component is “connected”, “coupled”, or “joined” to another component, a third component may be “connected”, “coupled”, and “joined” between the first and second components, although the first component may be directly connected, coupled, or joined to the second component.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

At least some functions of an apparatus or an electronic device provided in an embodiment may be implemented through an artificial intelligence (AI) model. For example, at least one module from among various modules of the apparatus or the electronic device may be implemented through the AI model. AI model-related functions may be performed by a non-volatile memory, a volatile memory, and at least one processor. However, the present disclosure is not limited in this regard.

The at least one processor may include one or more processors. As used herein, the one or more processors may be, for example, a general-purpose processor (e.g., a central processing unit (CPU), an application processor (AP), or the like), or a graphics-dedicated processing unit (e.g., a graphics processing unit (GPU), a vision processing unit (VPU), or the like), and/or an AI-dedicated processor (e.g., a neural processing unit (NPU) or the like).

The one or more processors may control the processing of input data based on a predefined operation rule and/or an AI model stored in a non-volatile memory and/or a volatile memory. The predefined operation rules and/or the AI model may be provided through training and/or learning.

As used herein, providing the AI model through learning may indicate generating a predefined operation rule and/or AI model with desired characteristics by applying a learning algorithm to a plurality of pieces of training data. The learning may be performed by an apparatus and/or an electronic device, on which an AI model is mounted (e.g., installed, executed), and/or by a separate server, apparatus, and/or system.

The AI model may include a plurality of neural network layers. A neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), or a deep Q network. However, the present disclosure is not limited in this regard.

The learning algorithm may be and/or may include a method of training a predetermined target device, for example, a robot, or the like, based on a plurality of pieces of training data and of enabling, allowing, and/or controlling the target device to perform a determination and/or a prediction. The learning algorithm may include, but is not limited to, for example, supervised learning, unsupervised learning, semi-supervised learning, reinforcement learning, or continual learning.

Although aspects of the present disclosure are generally directed to image processing, the aspects presented herein may also be applicable to other technologies and/or technical fields, such as, but not limited to, speech, language, image, video, data intelligence, or the like.

For example, in a case of a speech and/or language technical field, in a method performed by an electronic device, according to the present disclosure, a method of user speech recognition and user intent interpretation may include receiving a speech signal as an analog signal through a speech signal obtaining device (e.g., a microphone), and converting a speech portion into a computer-readable text using an automatic speech recognition (ASR) model. A user's utterance intent may be obtained by interpreting the converted text using a natural language understanding (NLU) model. The ASR model and/or the NLU model may be an AI model. The AI model may be processed by an AI-dedicated processor designed with a hardware architecture designated for AI model processing. The AI model may be obtained through training. As used herein, “being obtained through training” may refer to obtaining a predefined operation rule and/or AI model that may be configured to perform a desired feature (or objective) by training a basic AI model with a plurality of sets of training data through a training algorithm. Language understanding may include, but not be limited to, natural language processing, machine translation, dialogue system, question and answer, and speech recognition/synthesis, and/or may be a technology used to recognize and/or apply and/or process human language and/or text.

As another example, in a case of an image and/or video technical field, in a method performed by an electronic device, according to the present disclosure, a method of identifying an object may include obtaining output data for identifying an image or an image feature by using image data as input data of an AI model. The AI model may be obtained through training. The method of the present disclosure may relate to a visual understanding field of an AI technology, such as a technology for recognizing and processing objects, as in human visual perception. For example, the visual understanding of the AI technology may include, but not be limited to, object recognition, object tracking, image search, human recognition, scene recognition, three-dimensional (3D) reconstruction and/or positioning, image enhancement, or the like.

As another example, in a data intelligence processing field, in a method performed by an electronic device, according to the present disclosure, a method of inferring or predicting an object category may include inferring or predicting a category of an object by using feature data with an AI model. A processor of the electronic device may perform a preprocessing operation on data to convert the data into a form suitable for use as an input of an AI model. The AI model may be obtained through training. Inference and/or prediction may refer to a technology of determining information and performing logical inference and prediction, such as, but not limited to, knowledge-based inference, optimization prediction, preference-based planning, recommendation, or the like.

The same name may be used to describe an element included in the embodiments described above and an element having a common function. Unless otherwise mentioned, the descriptions on the embodiments may be applicable to the following embodiments and thus, duplicated descriptions may be omitted for the sake of brevity.

The present disclosure may provide a reference-CNN decoder-based large-scale dynamic scene neural rendering method and an electronic device for performing the same, which may improve a training speed, a rendering speed, and/or a rendering quality (e.g., a rendering quality at a new viewing angle), of a neural rendering algorithm for a large-scale dynamic scene.

The present disclosure may provide a method of retrieving priori information based on structural similarity. For example, in a training operation, the electronic device may collectively sample rays in a patch form (e.g., collectively sample a certain number of pixel points that may be understood as one region) for a training image (a high-resolution or low-resolution image), determine a similarity region of forward and backward training visions by using an optical flow, search for a patch with a highest structural similarity in the region in the unit of pixel, and use the corresponding high-resolution patch as a reference image. In an inference operation, the electronic device may calculate a structural similarity between a low-resolution volume rendering feature map and a low-resolution red, green, blue (RGB) image at a new viewing angle, and use a high-resolution RGB image with a highest structural similarity as a reference image.

The present disclosure may provide a decoder for decoding a low-resolution volume rendering feature map into a high-resolution RGB image, learning a relationship with a reference image during a decoding process, and potentially improving quality of a reconstructed image by utilizing information relevant to the reference image, when compared to a related decoder. In addition, combining low-resolution rendering with decoder upsampling may increase a rendering speed, when compared to a related decoder.

The technical concepts of the present disclosure are described with reference to the accompanying drawings.

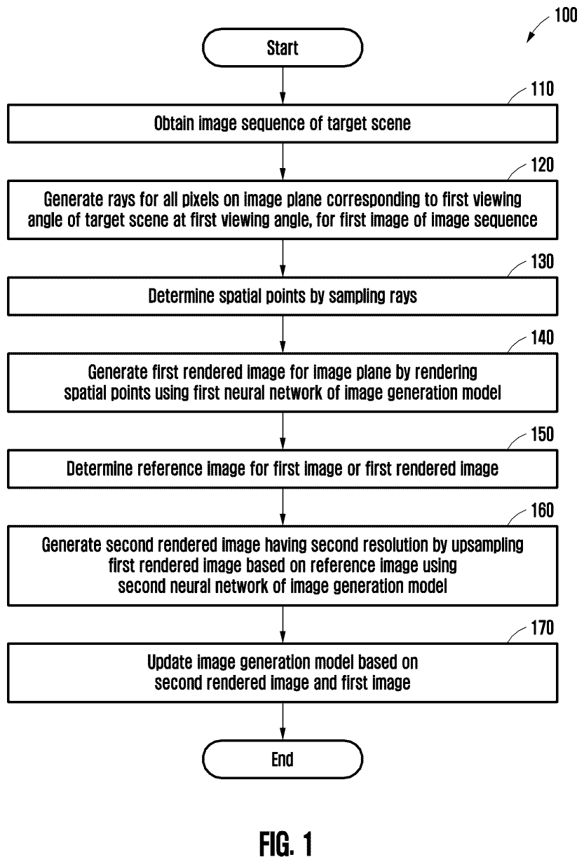

FIG. 1 is a flowchart of a method of updating an image generation model, according to an embodiment.

According to an embodiment, a method 100 of updating an image generation model may include operations 110 to 170. For example, operations 110 to 170 may be performed by an electronic device or by at least one processor of the electronic device. The electronic device may be and/or may include a handheld device (e.g., a smartphone, a mobile phone, a cellular phone, a tablet computer, a laptop computer, a digital camera, a personal digital assistant (PDA), a wearable device, a smart device, or the like), or a server (e.g., a desktop computer, a computer server, a network appliance, a virtual machine, or the like). The structure of the electronic device is described with reference to FIGS. 12 to 14.

In an embodiment, the method 100 of generating an image may generate (or reconstruct) an image of a target scene at a new viewing angle. When reconstructing the image of the target scene at the new viewing angle, the electronic device may reconstruct the image based on an image generation model described with reference to FIG. 1.

According to an embodiment, the image generation model may include a first neural network and a second neural network, and each neural network may be implemented as an arbitrary neural network. For example, the first neural network and/or the second neural network may be a neural network model based on neural radiance fields (NeRF). As another example, the first neural network and/or the second neural network may use a plurality of images imaged at multiple angles as an input, optimize a potentially continuous voxel scene equation based on the plurality of images, and obtain a complete 3D scene based on the plurality of images.

In operation 110, the electronic device may obtain an image sequence of a target scene. For example, the target scene may be and/or may include a specific scene to be targeted for a driving scene of a moving object (e.g., a vehicle, or the like). The electronic device may image a specific scene (e.g., a target scene) at a plurality of viewing angles to obtain an image sequence of the scene. For example, the image sequence may include a plurality of images obtained by imaging the target scene at different times (e.g., consecutive times) and/or at various viewing angles. As another example, the image sequence may include images of a target scene imaged at different imaging angles (e.g., viewing angles) regardless of the imaging time. As another example, the image sequence may include images of a target scene imaged at various imaging times regardless of the imaging angle.

In an embodiment, the image sequence may include a plurality of images having a first resolution. For example, the first resolution may be lower than a resolution (e.g., a second resolution) of an original image imaged for a specific scene. At least some of the plurality of images included in the image sequence may be used to train the image generation model described with reference to FIG. 1 (e.g., a training operation), and/or may be used to reconstruct an image at a new viewing angle (e.g., an inference operation).

In an embodiment, operation 110 may include obtaining the image sequence by downsampling an original image of the target scene. The plurality of images of the image sequence obtained by the downsampling may have the first resolution that may be lower than the resolution of the original image.

For example, the electronic device may downsample the original image of the target scene to use the downsampled image sequence as subsequent processing data after operation 110. When the image generation model is trained based on an image sequence having the first resolution that may be lower than the resolution of the original image, a training speed may be improved (e.g., increased) when compared to training the image generation model based on the original image.

In operation 120, the electronic device may generate rays for all pixels on an image plane corresponding to a first viewing angle of the target scene at the first viewing angle, for a first image of the image sequence. The first image may be and/or may include an image that may be imaged at the first viewing angle, which may be referred to as a known viewing angle.

The first image may be any image from among a plurality of images included in the image sequence. The first viewing angle may be a posture of a camera viewing the target scene. The posture of the camera may include camera coordinates in a world coordinate system and a rotation angle, for example. The image plane may be a plane on which light passing through a camera and/or a camera lens may be focused to form an image, when the camera views the target scene at the first viewing angle. For example, the image plane may include a plurality of pixels. Each of the plurality of pixels may represent a specific position on the image plane, and the plurality of pixels may be gathered to form one continuous image plane. As used herein, rays may refer to paths of light from the camera to all the pixels of the plurality of pixels that form the image plane.

In an embodiment, the image plane may include a target pixel region. The target pixel region may be the entire region and/or may include a partial region of the image plane.

In an embodiment, the electronic device may determine ray paths for all the pixels for the image plane corresponding to the first viewing angle, for the first image of the image sequence, when the target scene is viewed at the first viewing angle.

In operation 130, the electronic device may determine spatial points by sampling the rays. A spatial point may refer to a specific point in a 3D space corresponding to each pixel on the image plane.

In an embodiment, operation 130 may include determining the spatial points corresponding to a predetermined shape by sampling the rays according to the predetermined shape (e.g., a patch). For example, the predetermined shape may be a square. However, the present disclosure is not limited in this regard. That is, the predetermined shape may have various other forms without departing from the scope of the present disclosure. In an embodiment, the sampling of the rays may be collectively performed.

In operation 140, the electronic device may generate a first rendered image for the image plane by rendering the spatial points using a first neural network of the image generation model.

The electronic device may generate the first rendered image based on the determined spatial point. For example, the electronic device may visualize the spatial point in a two-dimensional (2D) image using the determined specific points in the 3D space. In an embodiment, the first rendered image may have the first resolution.

In operation 150, the electronic device may determine a reference image for the first image and/or the first rendered image. For example, among the plurality of images of the image sequence, a second image other than the first image may be determined as the reference image. That is, the second image may be an image having a high structural similarity to the first image from among the plurality of images included in the image sequence.

In an embodiment, the reference image may be and/or may include the entire region and/or a partial region of the second image corresponding to the image plane of the first image. For example, the reference image may be and/or may include a region having a high structural similarity to the image plane of the first image. In an embodiment, the reference image may be and/or may include the entire region and/or a partial region of the second image corresponding to the target pixel region of the first image. For example, the reference image may be and/or may include a region having a high structural similarity to the target pixel region of the first image.

In an embodiment, operation 150 may include generating optical flow information of the target scene, and determining the reference image from the image sequence based on the optical flow information. For example, the electronic device may determine a motion and/or change degree between the plurality of images in the image sequence of the target scene based on the optical flow information. The electronic device may determine the reference image based on the determined motion and change degree.

In an embodiment, the determining of the reference image from the image sequence based on the optical flow information may include determining a first previous image from among one or more previous images of the first image of the image sequence based on forward optical flow information of the optical flow information, determining a first following image from among one or more following images of the first image of the image sequence based on backward optical flow information of the optical flow information, and determining at least one of the first previous image and the first following image as the reference image.

For example, the first previous image may be and/or may include an image having a highest structural similarity to the target pixel region of the first image from among the one or more previous images. As another example, the first following image may be and/or may include an image having a highest structural similarity to the target pixel region of the first image from among the one or more following images. The first previous image and the first following image having a high similarity to the target pixel region may be determined based on the optical flow information and the reference image may be determined based on the similarity between the first previous image and the first following image, thereby potentially reducing the time required to determine the reference image.

In an embodiment, the determining of at least one of the first previous image and the first following image as the reference image may include determining at least one similar region from the first previous image or the first following image, and determining at least one of the first previous image and the first following image as the reference image by performing sliding window to the at least one similar region.

In operation 160, the electronic device may generate a second rendered image having a second resolution by upsampling the first rendered image based on the reference image using the second neural network of the image generation model.

In an embodiment, the electronic device may generate the second rendered image having the second resolution by upsampling the first rendered image having the first resolution using the second neural network. For example, the second resolution may be a resolution higher than the first resolution.

In an embodiment, the electronic device may reconstruct a final image by combining the upsampled first rendered image and the reference image using the second neural network. For example, the reconstructed final image may be the second rendered image.

In an embodiment, operation 160 may include generating the second rendered image by performing at least one of feature extraction, feature fusion, cascading residual processing, or feature decoding on the first rendered image and the reference image.

In an embodiment, the second neural network may include a feature extraction unit, a feature fusion unit, a cascaded residual processing unit, and a feature decoding unit. The electronic device may generate a first feature by extracting features of the first rendered image using the feature extraction unit of the second neural network. The electronic device may generate a second feature by extracting features of the reference image using the feature extraction unit of the second neural network. The electronic device may generate a third feature by fusing the first feature and the second feature using the feature fusion unit of the second neural network. The electronic device may generate a fourth feature by featuring the third feature using the cascading residual processing unit of the second neural network. The electronic device may generate the second rendered image by decoding the fourth feature using the feature decoding unit of the second neural network. In an embodiment, the second neural network may autonomously learn the similarity between the first rendered image and the reference image.

In an embodiment, the second neural network may further include an upsampling unit. The electronic device may generate the second rendered image having the second resolution by upsampling the first rendered image based on a reference image using the upsampling unit of the second neural network. The using of the upsampling unit of the second neural network by the electronic device may be performed in parallel or independently of the using of the feature extraction unit, the feature fusion unit, the cascading residual processing unit, or the feature decoding unit.

In operation 170, the electronic device may update the image generation model based on the second rendered image and the first image. In an embodiment, the electronic device may compare the second rendered image with the first image, and update the image generation model based on the comparison result. For example, the updating of the image generation model may include updating the first neural network and/or the second neural network.

In an embodiment, operation 170 may include obtaining sequence information related to at least one of a depth image sequence, an image feature sequence, and an optical flow sequence of a target scene, generating rendering information related to at least one of depth information, feature descriptor information, and optical flow information corresponding to all pixels of an image plane by rendering a plurality of rays using the first neural network, and updating the image generation model based on at least one of the sequence information or the rendering information and at least one of the second rendered image or the first image.

For example, each image constituting the depth image sequence, the image feature sequence, and the optical flow sequence may correspond to an original image of the first image. In an embodiment, a pixel point that constitutes one image of the depth image sequence may reflect the depth information of the corresponding pixel point. In an embodiment, a pixel point that constitutes one image of the image feature sequence may reflect the feature descriptor information of the corresponding pixel point. In an embodiment, a pixel point that constitutes one image of the optical flow sequence may reflect the optical flow information of the corresponding pixel point.

The electronic device may generate at least one of the depth information, the feature descriptor information, and the optical flow information corresponding to each pixel of the image plane by rendering a plurality of sampled rays using the first neural network. For example, the electronic device may obtain the depth information, the optical flow information, and/or the feature descriptor information corresponding to each pixel by rendering the collectively sampled rays using the NeRF model.

The electronic device may train the image generation model based on at least one of the generated depth information and corresponding depth information from the depth image sequence, the generated feature descriptor information and corresponding feature descriptor information from the image feature sequence, the generated optical flow information and corresponding optical flow information from the optical flow sequence, or the second rendered image or the original image corresponding to the first image.

For example, the electronic device may, for the image plane, generate a first loss function using the generated depth information and the depth information corresponding to the depth image sequence, generate a second loss function using the generated feature descriptor information and the feature descriptor information corresponding to the image feature sequence, generate a third loss function using the generated optical flow information and the optical flow information corresponding to the optical flow sequence, generate a fourth loss function using the second rendered image or the original image corresponding to the first image, generate a total loss function based on the first to fourth loss functions, and train each network parameter of the image generation model to minimize a loss value of the total loss function.

In an example, in order to potentially improve a model training speed, the electronic device may obtain at least one of an original depth image sequence, an original image feature sequence, and an original optical flow sequence by processing an original image sequence of a target scene, and obtain a depth image sequence, an image feature sequence, and an optical flow sequence to be used for model training by downsampling at least one of the original depth image sequence, the original image feature sequence, and the original optical flow sequence. That is, the electronic device may potentially reduce a model training time by training the model using a depth image sequence, an image feature sequence, and an optical flow sequence having a low resolution.

In an embodiment, the obtaining of the sequence information related to at least one of the depth image sequence, the image feature sequence, and the optical flow sequence of the target scene may include obtaining at least one of the original depth image sequence, the original image feature sequence, and the original optical flow sequence based on the original image sequence of the target scene, and obtaining the sequence information related to at least one of the depth image sequence, the image feature sequence, and the optical flow sequence of the target scene by downsampling at least one of the original depth image sequence, the original image feature sequence, and the original optical flow sequence.

In an embodiment, the electronic device may generate a loss function based on the second rendered image and the first image (or the original image of the first image), and update the image generation model to minimize the loss value of the loss function.

In an embodiment, a method of updating an image generation model may include obtaining an image sequence of a target scene and information about a first viewing angle, wherein the image sequence includes a plurality of images having a first resolution, generating rays for all pixels of an image plane corresponding to the first viewing angle of the target scene at the first viewing angle, determining spatial points by sampling the rays, generating a first rendered image for the image plane by rendering the spatial points using a first neural network, wherein the first rendered image has the first resolution, determining a reference image for the first rendered image from among the plurality of images of the image sequence, and generating a second rendered image having a second resolution by upsampling the first rendered image based on the reference image using a second neural network.

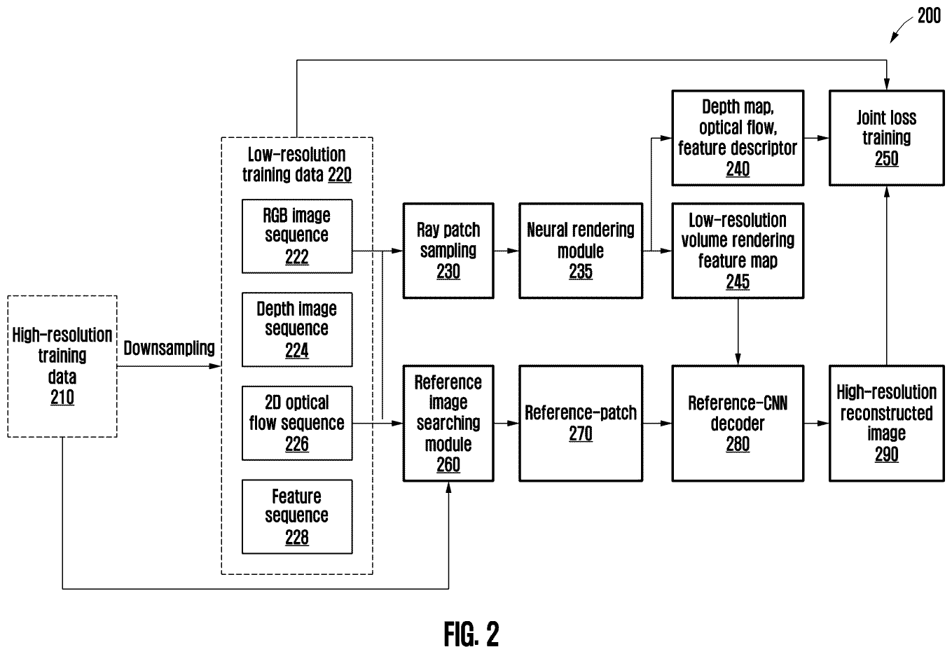

FIG. 2 is a flowchart illustrating a method of updating an image generation model, according to an embodiment.

Referring to FIG. 2, a method 200 may include, after obtaining a video sequence of a specific scene, using the video sequence as training data for an image generation model, that is, high-resolution training data 210.

In order to potentially increase a model training speed, the electronic device may obtain low-resolution training data 220 by downsampling the high-resolution training data 210. The low-resolution training data 220 may include an RGB image sequence 222, a depth image sequence 224, a 2D optical flow sequence 226, and/or a feature sequence 228 (e.g., an image feature sequence).

For example, the electronic device may perform the downsampling, and preprocess the downsampled image sequence with reference to a scalable urban dynamic scenes (SUDS) algorithm to generate a camera pose corresponding to the RGB image sequence 222 of the target scene, a sparse LiDAR depth image, a 2D self-distillation with no labels (DINO) feature descriptor, and 2D optical flow information, or the like. In an embodiment, the electronic device may generate the corresponding low-resolution training data 220 using a three-times (3×) downsampling process.

For low-resolution training data 220 of the target scene, a target pixel region (e.g., corresponding to a sampled ray patch) may be randomly sampled using a ray patch sampling module 230.

A reference image searching module 260 may determine similar regions from among forward and backward RGB images from the RGB image (e.g., high-resolution training data 210) of a known viewing angle using corresponding patch coordinates and 2D forward and backward optical flows, calculate a structural similarity between the sampled patches by sliding a window in units of pixel in two (2) similar regions to search for a patch having a highest structural similarity, and select a corresponding high-resolution patch from the high-resolution training data as the reference image (e.g., a reference-patch 270).

A neural rendering module 235 (e.g., the first neural network) may output a low-resolution volume rendering feature map 245 by rendering a sampled ray patch using the SUDS neural rendering algorithm.

The reference image 270 and the low-resolution volume rendering feature map 245 obtained above may be input to a reference-CNN decoder 280 (e.g., the second neural network) to generate a high-resolution reconstructed image 290.

The second neural network may perform the upsampling function. After the reference image 270 and the low-resolution volume rendering feature map 245 are input to the reference-CNN decoder 280, the reference-CNN decoder 280 may decode the low-resolution volume rendering feature map 245 into a high-resolution image, and then reconstruct an image by using the high-resolution image and the reference image 270.

The image generation model of the present disclosure may be trained using various loss functions. For example, when a model is trained using the depth information, the optical flow information, the feature descriptor information, and the reconstructed image, a loss function may be generated based on the depth information, the optical flow information, the feature descriptor information output by the neural rendering module, and the corresponding real depth information, optical flow information, and feature descriptor information 240. For example, a loss function may be generated based on the reconstructed image and a real RGB image corresponding thereto. The electronic device may update the image generation model by performing joint training 250 using these loss functions.

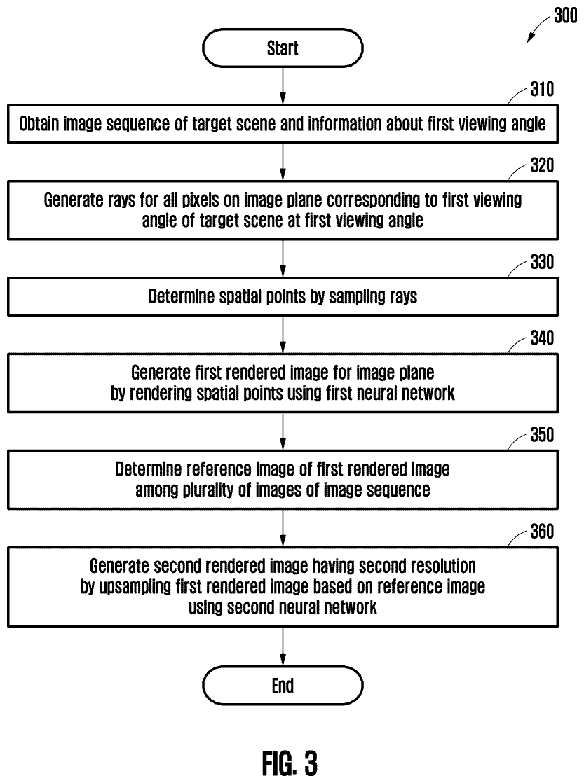

FIG. 3 is a flowchart of a method of generating an image, according to an embodiment.

According to an embodiment, a method 300 of generating an image may include operations 310 to 360. For example, operations 310 to 360 may be performed by an electronic device or by at least one processor of the electronic device. The electronic device may be and/or may include a handheld device (e.g., a smartphone, a mobile phone, a cellular phone, a tablet computer, a laptop computer, a digital camera, a PDA, a wearable device, a smart device, or the like), or a server (e.g., a desktop computer, a computer server, a network appliance, a virtual machine, or the like). The structure of the electronic device is described with reference to FIGS. 12 to 14.

Operations 320, 330, and 340 of method 300 may include and/or may be similar in many respects to the operations 120, 130, and 140 described above with reference to FIG. 1, respectively, and may include additional features not mentioned above. Consequently, repeated descriptions of the operations 320, 330, and 340 described above with reference to FIG. 1 may be omitted for the sake of brevity.

According to an embodiment, the method 300 of generating an image may generate (or reconstruct) an image of a target scene at a new viewing angle. When reconstructing the image of the target scene at the new viewing angle, the electronic device may reconstruct the image based on an image generation model described with reference to FIG. 1.

According to an embodiment, the image generation model may include a first neural network and a second neural network, and each neural network may be implemented as an arbitrary neural network. For example, the first neural network and/or the second neural network may be a neural network model based on NeRF. In an embodiment, the first neural network and/or the second neural network may use a plurality of images imaged at multiple angles as an input, optimize a potentially continuous voxel scene equation based on the plurality of images, and obtain a complete 3D scene based on the plurality of images.

In operation 310, the electronic device may obtain the image sequence of the target scene and the information about the first viewing angle. For example, the target scene may be and/or may include any scene from which a final image (e.g., a second rendered image) is to be generated based on the method 300 of generating an image. For example, the first viewing angle may be a new viewing angle from which the final image is to be generated based on the method 300 of generating an image. The information about the first viewing angle may be a posture of a camera viewing the target scene.

In an embodiment, the image sequence may include a plurality of images having a first resolution. For example, the first resolution may be lower than a resolution of an original image obtained by imaging a specific scene.

In an embodiment, operation 310 may include obtaining an image sequence by downsampling an original image of the target scene. Based on the downsampling, the plurality of images of the image sequence may have the first resolution. The first resolution may be a comparatively low resolution.

In operation 320, the electronic device may generate rays for all pixels on an image plane corresponding to the first viewing angle of the target scene at the first viewing angle. The electronic device may set the image plane for a case of viewing the target scene at a new viewing angle from which the final image is to be generated. According to operation 120 described above with reference to FIG. 1, the electronic device may generate rays for all pixels on the image plane corresponding to the new viewing angle.

In operation 330, the electronic device may determine spatial points by sampling the rays. According to operation 130 described above with reference to FIG. 1, the electronic device may determine spatial points by sampling the rays. In an embodiment, the electronic device may sample the rays for each region according to a shape, based on a predetermined shape. For example, the sampling of the rays may be performed collectively.

In operation 340, the electronic device may generate a first rendered image for the image plane by rendering the spatial points using the first neural network. According to operation 140 described above with reference to FIG. 1, the electronic device may generate the first rendered image for the image plane. In an embodiment, the electronic device may render the rays for each region according to the shape, based on a predefined shape. For example, the electronic device may generate an overall rendered image based on the rendering result for each region. For example, the first rendered image may have the first resolution.

In operation 350, the electronic device may determine a reference image of the first rendered image from among the plurality of images of the image sequence. For example, the reference image may be and/or may include an image having a high structural similarity to the first rendered image from among the plurality of images of the image sequence.

In an embodiment, operation 350 may include generating optical flow information of the target scene, and determining the reference image from the image sequence based on the optical flow information.

In an embodiment, the determining of the reference image from the image sequence based on the optical flow information may include determining a first previous image from among one or more previous images of the first rendered image of the plurality of images of the image sequence based on forward optical flow information of the optical flow information, determining a first following image from among one or more following images of the first rendered image of the plurality of images of the image sequence based on backward optical flow information of the optical flow information, and determining at least one of the first previous image and the first following image as the reference image.

In an embodiment, the determining of the at least one of the first previous image or the first following image as the reference image may include determining at least one similar region from the first previous image or the first following image, and determining at least one of the first previous image or the first following image as the reference image by performing a sliding window on the at least one similar region.

The operation 350 of determining the reference image based on the optical flow information is merely an example, and the present disclosure is not limited thereto.

In operation 360, the electronic device may generate a second rendered image having a second resolution by upsampling the first rendered image based on the reference image using a second neural network of the image generation model. In an embodiment, the second rendered image may be and/or may include an image of the target scene reconstructed through a new viewing angle.

In an embodiment, the electronic device may generate the second rendered image having the second resolution by upsampling the first rendered image having the first resolution using the second neural network. For example, the second resolution may be a resolution higher than the first resolution.

In an embodiment, the electronic device may reconstruct a final image by combining the upsampled first rendered image and the reference image using the second neural network. For example, the reconstructed final image may be the second rendered image.

In an embodiment, operation 360 may include generating a first feature by extracting features of the first rendered image, generating a second feature by extracting features of the reference image, generating a third feature by fusing the first feature and the second feature, generating a fourth feature by featuring the third feature, and generating the second rendered image by decoding the fourth feature.

In the inference operation, the image generation model may sample rays of all pixels for all the images, generate a first rendered image for the first viewing angle by rendering all the sampled rays, search for a reference image having a highest structural similarity to the first rendered image from among all images of all viewing angles, and generate a second rendered image based on the first rendered image and the reference image.

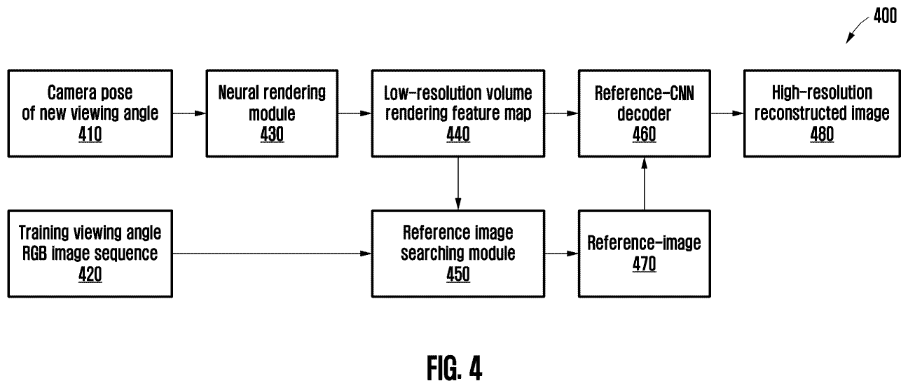

FIG. 4 is a flowchart illustrating a method of generating an image, according to an embodiment.

Referring to FIG. 4, rays of pixels for the first viewing angle 410, which is a new viewing angle, may be sampled, and the neural rendering module 430 may use the SUDS neural rendering algorithm to output the entire low-resolution volume rendering feature map 440 of the first viewing angle. The reference image searching module 450 may calculate a structural similarity between the volume rendering feature map 440 and RGB images of all training viewing angles 420 (e.g., known viewing angles) to determine an image having a highest structural similarity as a viewing angle image, a high-resolution image corresponding to the determined viewing angle image may be determined as a reference image 470, and the low-resolution volume rendering feature map 440 and the reference image 470 is input to a reference-CNN decoder 460 to generate a reconstructed image of the viewing angle 480.

According to an embodiment, the electronic device may use a plurality of loss functions in joint training, and individually train each neural network.

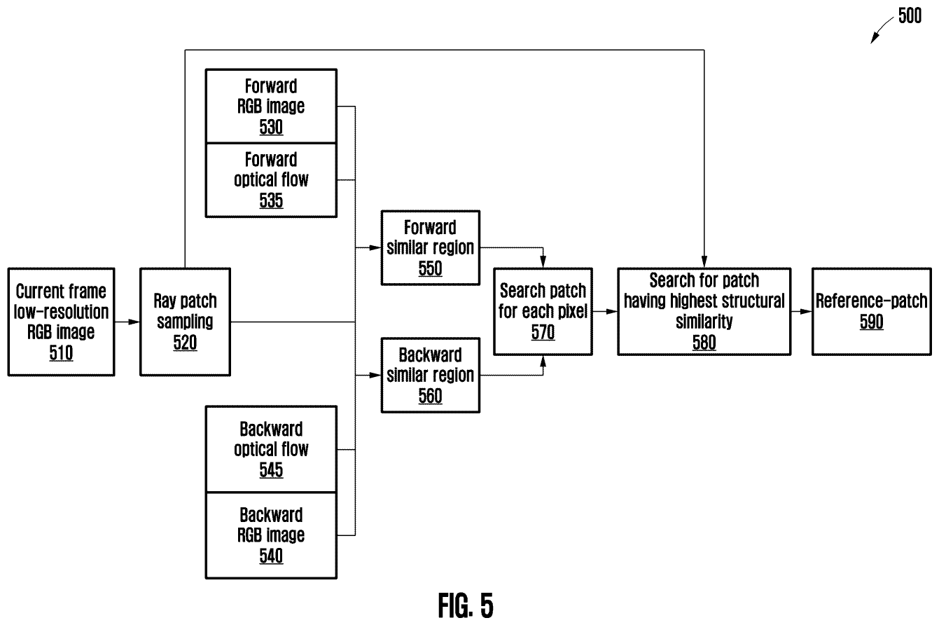

FIG. 5 is a flowchart illustrating a method of determining a reference image in a training operation, according to an embodiment.

The description of the flowchart 500 is made using an image (or a frame) of an image sequence as an example.

Referring to FIG. 5, the electronic device may obtain a current low-resolution RGB image 510 by downsampling the original RGB image of the current image, and obtain a ray patch 520 by collectively sampling the ray. A forward similar region 550 similar to a ray patch 520 may be searched and found using forward optical flow information 535 and a previous image 530 (e.g., a forward RGB image 530) of the current image, and a backward similar region 560 similar to a ray patch 520 may be searched and found using backward optical flow information 545 and a following image 540 (e.g., a backward RGB image 540) of the current image. For example, since the forward similar regions 550 and the backward similar region 560 are larger than the ray patch 520 (e.g., the target pixel region), similar patches may be searched relatively more accurately when calculating structural similarity by sliding the window pixel by pixel (e.g., search patch for each pixel 570). The size of the sliding window may be set according to the target pixel region. The electronic device may find a patch having a highest structural similarity 580, and determine a reference image 590 corresponding to that patch from a corresponding previous image or following image.

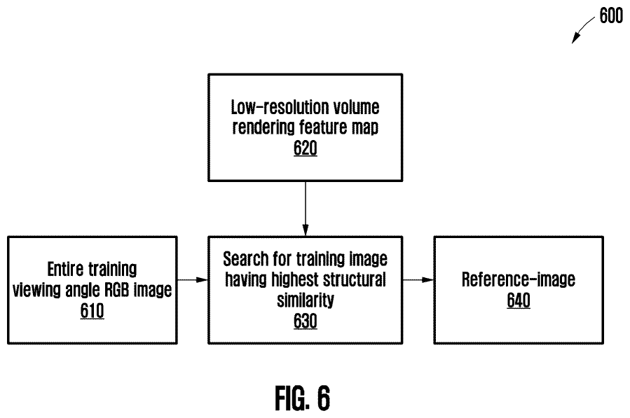

FIG. 6 is a flowchart illustrating a method of determining a reference image in an inference operation, according to an embodiment.

In the inference operation 600, the reference image searching module may be used for the entire image. The reference image searching module may first sequentially collectively sample rays of all pixels for all viewing angles, and then output a full low-resolution volume rendering feature map 620 of the corresponding viewing angle using the SUDS neural rendering algorithm.

Referring to FIG. 6, the reference image searching module 630 may search for a reference image 640 corresponding to the low-resolution volume rendering feature map 620 for reconstruction of the following image from among all training viewing angle RGB images 610. The searched reference image 640 may be a high-resolution image since the searching may be performed on a high-resolution original image.

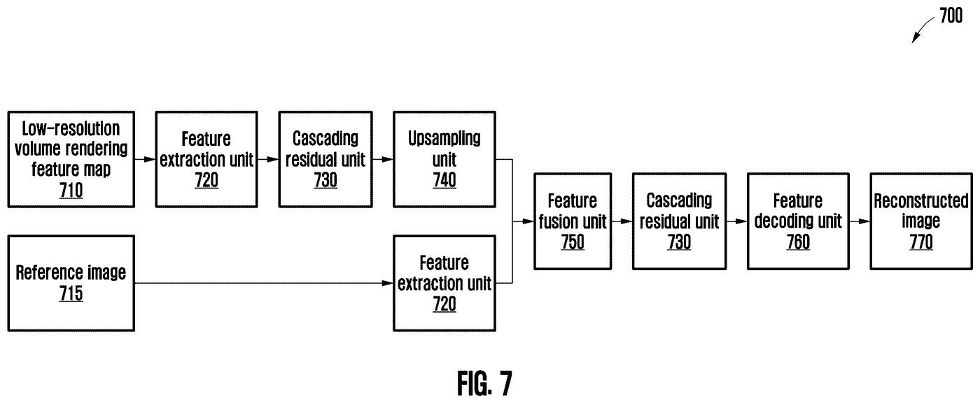

FIG. 7 is a flowchart 700 illustrating a method of using a reference CNN decoder module, according to an embodiment.

The electronic device may fuse information relevant to a reference image 715 by decoding a volume rendering feature map 710 using a lightweight reference-CNN decoder, in order to potentially avoid increasing a training time, when compared to related decoders. For example, the reference-CNN decoder may include a feature extraction unit 720, a cascading residual processing unit 730, an upsampling unit 740, a feature fusion unit 750, a feature decoding unit 760, and the like. The above examples are merely examples, and the implementation of the reference-CNN decoder is not limited to the described embodiments.

The electronic device may obtain a low-resolution volume rendering feature map 710, extract features for the low-resolution volume rendering feature map through the feature extraction unit 720, perform residual processing through the cascading residual processing unit 730, and upsample an output result of the cascading residual processing unit through the upsampling unit 740 to obtain a corresponding high-resolution feature map. The electronic device may extract features for a reference image 715 through the feature extraction unit 720 to obtain a corresponding feature map. The electronic device may fuse feature maps extracted as described above through the feature fusion unit 750, perform processing through the cascading residual unit 730, and decode the features through the feature decoding unit 760 to obtain a reconstructed image 770.

Referring to FIG. 7, the electronic device may obtain a high-resolution feature map by sequentially inputting the low-resolution volume rendering feature map 710 to the feature extraction unit 720, the cascading residual processing unit 730, and the upsampling unit 740. The feature extraction unit 720 may be implemented with a MeanShift layer and a 3×1 sized convolutional layer.

The upsampling unit 740 may be implemented with a 3×1 convolutional layer and a PixelShuffle layer. However, the present disclosure is not limited in this regard.

In an embodiment, a reference image 715 may be input to the feature extraction unit 720. The electronic device may fuse and/or merge a volume rendering feature map 710 and features of the reference image 715, fuse and compress the features using a 1×1 convolutional layer, and sequentially input the result to the cascading residual processing unit 730 and the feature decoding unit 760 to obtain a final high-resolution reconstructed image 770. For example, the feature decoding unit 760 may be implemented with a 3×1 convolutional layer and a MeanShift layer. The structure of each unit shown in FIG. 7 is merely an example, and the present disclosure is not limited thereto.

The number and arrangement of units and/or components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Alternatively or additionally, a set of (one or more) components shown in FIG. 7 may be integrated with each other, and/or may be implemented as an integrated circuit, as software, and/or a combination of circuits and software.

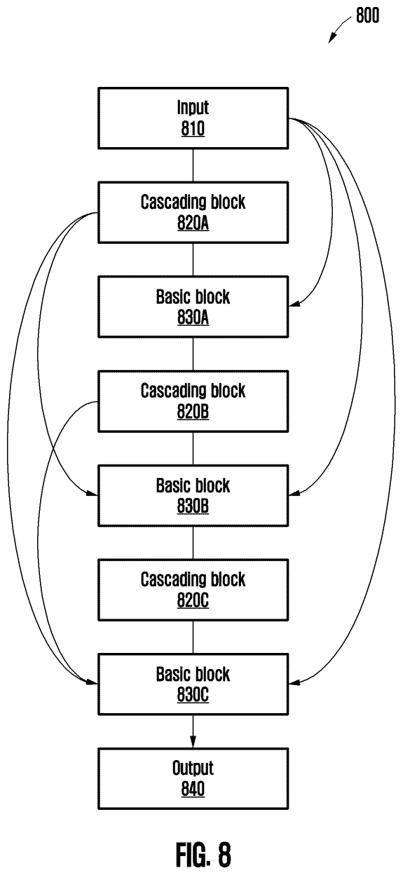

FIG. 8 illustrates a cascading residual processing unit, according to an embodiment.

Referring to FIG. 8, a cascading residual unit (CRU) 800 may integrate characteristics of a plurality of layers using a cascading mechanism at local levels (e.g., within a cascading block, between residual blocks) and/or global levels (e.g., between cascading blocks), and reflect input representations at various levels to receive more information. The CRU 800 may be implemented with an input block 810, at least one cascading block (e.g., a first cascading block 820A, a second cascading block 820B, and a third cascading block 820C), at least one basic block (e.g., a first basic block 830A, a second basic block 830B, and a third basic block 830C), and an output block 840.

The number and arrangement of components of the CRU 800 shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Alternatively or additionally, a set of (one or more) components shown in FIG. 8 may be integrated with each other, and/or may be implemented as an integrated circuit, as software, and/or a combination of circuits and software.

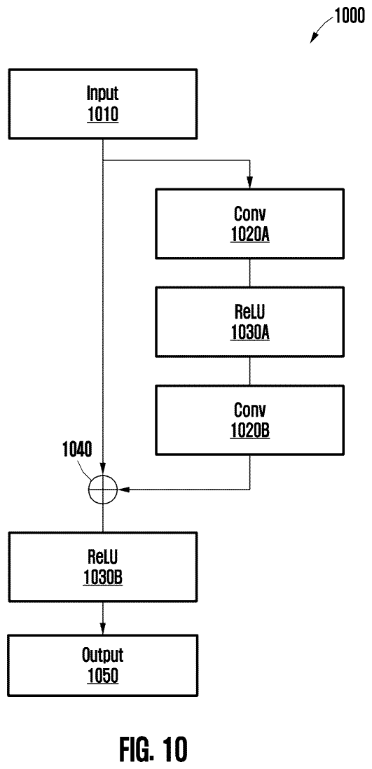

For example, three (3) residual blocks (e.g., residual block 1000 of FIG. 10) may be grouped to for one (1) cascading block (e.g., first to third cascading blocks 820A to 820C). Alternatively or additionally, a 1×1 convolution kernel for fusing and compressing an output of a previous cascading block may be positioned between the cascading blocks.

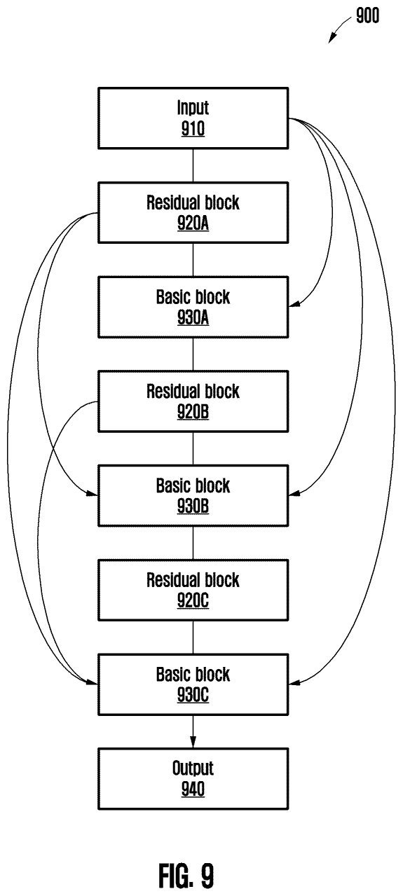

FIG. 9 illustrates a cascading block, according to an embodiment.

Referring to FIG. 9, a cascading block 900 may be implemented with an input block 910, at least one residual block (e.g., a first residual block 920A, a second residual block 920B, and a third residual block 920C), at least one basic block (e.g., a first basic block 930A, a second basic block 930B, and a third basic block 930C), and an output block 940.

The cascading block 900 may include and/or may be similar in many respects to the first to third cascading blocks 820A to 820C described above with reference to FIG. 8, and may include additional features not mentioned above. Consequently, repeated descriptions of the cascading block 900 described above with reference to FIG. 8 may be omitted for the sake of brevity.

The number and arrangement of components of the cascading block 900 shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Alternatively or additionally, a set of (one or more) components shown in FIG. 9 may be integrated with each other, and/or may be implemented as an integrated circuit, as software, and/or a combination of circuits and software.

FIG. 10 illustrates a residual block, according to an embodiment.

Referring to FIG. 10, a residual block 1000 may include and/or may be similar in many respects to the first to third residual blocks 920A to 920C described above with reference to FIG. 9, and may include additional features not mentioned above. Consequently, repeated descriptions of the residual block 1000 described above with reference to FIG. 9 may be omitted for the sake of brevity.

As shown in FIG. 10, the residual block 1000 may be implemented with an input layer 1010, two (2) or more convolutional layers (e.g., a first convolutional layer 1020A and a second convolutional layer 1020B), two (2) or more activation layers (e.g., a first activation layer 1030A and a second activation layer 1030B), a residual adder 1040, and an output layer 1050. The first and second convolutional layers 1020A and 1020B may be and/or may include 3×1 convolutional layers, for example. As another example, the first and second activation layers 1030A and 1030B may be and/or may include rectified linear units (ReLUs). However, the present disclosure is not limited in this regard.

The number and arrangement of components of the residual block 1000 shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Alternatively or additionally, a set of (one or more) components shown in FIG. 10 may be integrated with each other, and/or may be implemented as an integrated circuit, as software, and/or a combination of circuits and software.

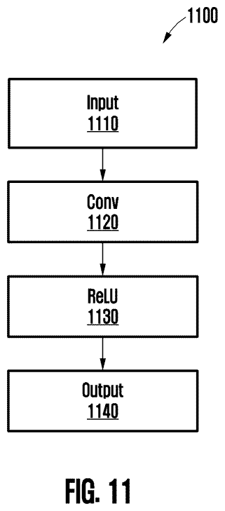

FIG. 11 illustrates a basic block, according to an embodiment.

Referring to FIG. 11, a basic block 1100 may include and/or may be similar in many respects to the first to third basic blocks 830A to 830C and 930A to 930C described above with reference to FIGS. 8 and 9, and may include additional features not mentioned above. Consequently, repeated descriptions of the basic block 1100 described above with reference to FIGS. 8 and 9 may be omitted for the sake of brevity.

Referring to FIG. 11, the basic block 1100 may be implemented with an input layer 1110, a convolutional layer 1120, an activation layer 1130, and an output layer 1140. The convolutional layer 1120 may be and/or may include a 1×1 convolutional layer, for example. As another example, the activation layer 1130 may be and/or may include a ReLU. However, the present disclosure is not limited in this regard.

Aspects of the present disclosure may provide for improvements in the effect of the reconstruction quality of an entire scene by uniformly utilizing high-quality reference information of different viewing angles for both static background and dynamic objects in a large-scale dynamic scene.

In addition, in the present disclosure, in order to quickly find reference information having a highest relevance, similar regions may be determined at forward and backward viewing angles in the training operation using an optical flow, and a patch having a highest structural similarity in the region may be searched with the reference image. Accordingly, a problem of excessively long training time caused by full-image search may be prevented and/or reduced. For example, the present disclosure may reduce the training time by changing random point sampling to patch collective sampling.

In addition, the present disclosure may provide a reference-CNN decoder to decode a low-resolution volume rendering feature map. Compared with related decoders, the reference-CNN decoder may automatically learn the correlation between the reference images and the volume rendering feature map, and improve the quality of a reconstructed image by using the relevant high-quality information of the reference image. In order to potentially avoid additional increase in training time and rendering time, the provided reference-CNN decoder designed may be lightweight, which may significantly reduce the rendering time. The methods disclosed in the present disclosure may be implemented as software in devices such as, but not limited to, an autonomous driving test system, a virtual reality (VR) and/or augmented reality (AR) device, or the like.

FIG. 12 illustrates an electronic device for performing a method of generating an image, according to an embodiment.

Referring to FIG. 12, an electronic device 1200 may include an obtaining module 1201, a sampling module 1202, a rendering module 1203, a searching module 1204, and a reconstruction module 1205. In an embodiment, the electronic device 1200 may include at least one processor, and the at least one processor may include the obtaining module 1201, the sampling module 1202, the rendering module 1203, the searching module 1204, and the reconstruction module 1205. Alternatively or additionally, the at least one processor may read and/or execute, individually or collectively, instructions from a memory storing said instructions to perform and/or implement the obtaining module 1201, the sampling module 1202, the rendering module 1203, the searching module 1204, and the reconstruction module 1205. The number, names, and types of modules included in the processor and/or the memory are merely examples, and the above modules may be combined into a single entity or divided into multiple entities, and their names may vary depending on their function.

The obtaining module 1201 may obtain an image sequence of a target scene and information about a first viewing angle.

The sampling module 1202 may generate rays for all pixels of an image plane corresponding to the first viewing angle of the target scene at the first viewing angle, and determine spatial points by sampling the rays.

The rendering module 1203 may generate a first rendered image for the image plane by rendering the spatial points using a first neural network.

The searching module 1204 may determine a reference image for the first rendered image from among a plurality of images of the image sequence.

The reconstruction module 1205 may generate a second rendered image having a second resolution by upsampling the first rendered image based on the reference image using a second neural network.

In an embodiment, the obtaining module 1201 may obtain the image sequence by downsampling original images of the target scene.

In an embodiment, the searching module 1204 may generate optical flow information of the target scene, and determine the reference image from the image sequence based on the optical flow information.

In an embodiment, the searching module 1204 may determine a first previous image from among one or more previous images of the first rendered image from among the plurality of images of the image sequence based on forward optical flow information of the optical flow information, determine a first following image from among one or more following images of the first rendered image from among the plurality of images of the image sequence based on backward optical flow information of the optical flow information, and determine at least one of the first previous image and the first following image as the reference image

In an embodiment, the searching module 1204 may determine at least one similar region from the first previous image or the first following image, and determine at least one of the first previous image and the first following image as the reference image by performing sliding window to the at least one similar region.

In an embodiment, the reconstruction module 1205 may generate a first feature by extracting features of the first rendered image, generate a second feature by extracting features of the reference image, generate a third feature by fusing the first feature and the second feature, generate a fourth feature by featuring the third feature, and generate the second rendered image by decoding the fourth feature.

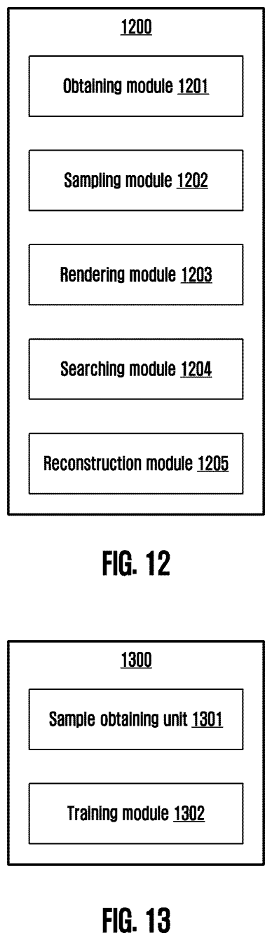

FIG. 13 illustrates an electronic device for performing a method of updating an image generation model, according to an embodiment.

Referring to FIG. 13, an electronic device 1300 may include a sample obtaining module 1301 and a training module 1302. In an embodiment, the electronic device 1300 may include at least one processor, and the at least one processor may include the sample obtaining module 1301 and the training module 1302. Alternatively or additionally, the at least one processor may read and/or execute, individually or collectively, instructions from a memory storing said instructions to perform and/or implement the sample obtaining module 1301 and the training module 1302. The number, names, and types of modules included in the at least one processor and/or memory are merely examples, and the above modules may be combined into a single entity or divided into multiple entities, and their names may vary depending on their function.

The sample obtaining module 1301 may obtain an image sequence of a target scene.

The training module 1302 may generate, for a first image of the image sequence, rays for all pixels of an image plane corresponding to a first viewing angle of the target scene at the first viewing angle.

The training module 1302 may determine spatial points by sampling the rays.

The training module 1302 may generate a first rendered image for the image plane by rendering the spatial points using a first neural network of the image generation model.

The training module 1302 may determine a reference image for a second image of the image sequence.

The training module 1302 may generate a second rendered image having a second resolution by upsampling the first rendered image based on the reference image using a second neural network of the image generation model.

The training module 1302 may update the image generation model based on the second rendered image and the first image.

In an embodiment, the training module 1302 may determine the spatial points corresponding to a predetermined shape by sampling the rays according to the predetermined shape.

In an embodiment, the training module 1302 may generate optical flow information of the target scene, and determine the reference image from the image sequence based on the optical flow information.

In an embodiment, the training module 1302 may generate the second rendered image by performing at least one of feature extraction, feature fusion, cascading residual processing, or feature decoding on the first rendered image and the reference image.

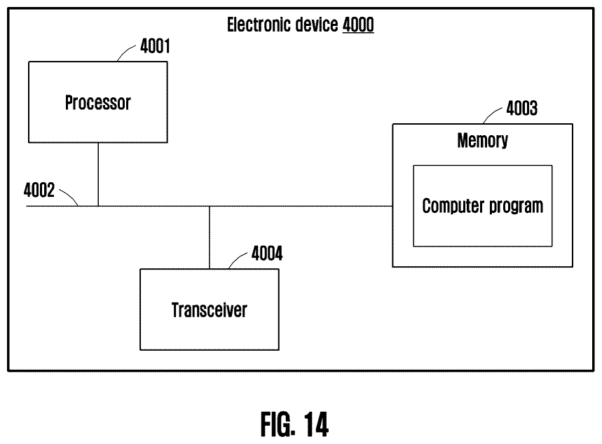

FIG. 14 illustrates a structure of an electronic device, according to an embodiment.

Referring to FIG. 14, an electronic device 4000 may include at least one processor 4001 and a memory 4003. The at least one processor 4001 and the memory 4003 may be connected to each other. For example, the at least one processor 4001 and the memory 4003 may be connected to each other via a bus 4002. Optionally, the electronic device 4000 may further include a transceiver 4004, and the transceiver 4004 may be used for data interchange, such as data transmission and/or data reception between the electronic device 4000 and another electronic device. In actual application, the transceiver 4004 is not limited to one transceiver, and the structure of the electronic device 4000 is not limited to the described embodiments. Optionally, the electronic device 4000 may be and/or may include a first network node, a second network node, or a third network node.

The at least one processor 4001 may be a CPU, a general-purpose processor, a digital signal processor (DSP), an application specific integrated circuit (ASIC), a field programmable gate array (FPGA) or other programmable logic device, a transistor logic device, a hardware component, or any combination thereof. The at least one processor 4001 may implement or execute various exemplary logic blocks, modules, or circuits. For example, the at least one processor 4001 may be a combination that realizes computing functions, including a combination of one or more microprocessors, a combination of a DSP and a microprocessor, or the like.

The bus 4002 may include a path for transmitting information between the components described above. The bus 4002 may be a peripheral component interconnect (PCI) bus or an extended industry standard architecture (EISA) bus. The bus 4002 may be classified into an address bus, a data bus, a control bus, and the like. For convenience of description, FIG. 14 represents the bus 4002 using only one bold line, however, the number and type of buses are not limited to the described embodiments.

The memory 4003 may be and/or may include a read-only memory (ROM) or other type of static storage capable of storing static information and instructions, a random access memory (RAM) or other type of dynamic storage capable of storing information and instructions, and may also be an electrically erasable programmable ROM (EEPROM), a compact disc ROM (CD-ROM) or other optical disk storage, an optical disk storage (e.g., a compressed optical disk, a laser disk, an optical disk, a digital versatile disk (DVD), a Blu-ray disk, or the like), a disk storage medium, other magnetic storage devices, or any other medium that may be used to carry or store a computer program and that may be readable by a computer. However, the present disclosure is not limited thereto.

The memory 4003 may be used to store computer programs and/or instructions for executing various described embodiments, and the computer programs or instructions may be controlled and executed by the at least one processor 4001. The at least one processor 4001 may execute the computer programs or instructions stored in the memory 4003 individually or collectively to cause the electronic device 4000 to perform or implement various embodiments or operations of the embodiments described here.

In an embodiment, the electronic device 4000 may include the at least one processor 4001 and the memory 4003 storing instructions. The instructions may be configured to, when individually or collectively executed by the at least one processor 4001, cause the electronic device 4000 to obtain an image sequence of a target scene and information about a first viewing angle, wherein the image sequence includes a plurality of images having a first resolution, generate rays for all pixels of an image plane corresponding to the first viewing angle of the target scene at the first viewing angle, determine spatial points by sampling the rays, generate a first rendered image for the image plane by rendering the spatial points using a first neural network, wherein the first rendered image has the first resolution, determine a reference image for the first rendered image from among the plurality of images of the image sequence, and generate a second rendered image having a second resolution by upsampling the first rendered image based on the reference image using a second neural network.

In an embodiment, the instructions may be configured to, when individually or collectively executed by the at least one processor 4001, cause the electronic device 4000 to obtain the image sequence by downsampling an original image of the target scene.

In an embodiment, the instructions may be configured to, when individually or collectively executed by the at least one processor 4001, cause the electronic device 4000 to generate optical flow information of the target scene, and determine the reference image from the image sequence based on the optical flow information.

In an embodiment, the instructions may be configured to, when individually or collectively executed by the at least one processor 4001, cause the electronic device 4000 to determine a first previous image from among one or more previous images of the first rendered image from among the plurality of images of the image sequence based on forward optical flow information of the optical flow information, determine a first following image from among one or more following images of the first rendered image from among the plurality of images of the image sequence based on backward optical flow information of the optical flow information, and determine at least one of the first previous image and the first following image as the reference image.

In an embodiment, the instructions may be configured to, when individually or collectively executed by the at least one processor 4001, cause the electronic device 4000 to determine at least one similar region from the first previous image or the first following image, and determine at least one of the first previous image and the first following image as the reference image by performing sliding window to the at least one similar region.

In an embodiment, the instructions may be configured to, when individually or collectively executed by the at least one processor 4001, cause the electronic device 4000 to generate a first feature by extracting features of the first rendered image, generate a second feature by extracting features of the reference image, generate a third feature by fusing the first feature and the second feature, generate a fourth feature by featuring the third feature, and generate the second rendered image by decoding the fourth feature.

In an embodiment, the first neural network may be a neural network based on a NeRF model.

The methods, according to the above-described embodiments, may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as, but not limited to, hard disks, floppy disks, and magnetic tape; optical media such as CD-ROM discs and/or DVDs; magneto-optical media such as, but not limited to, optical discs; and hardware devices that are specially configured to store and perform program instructions, such as, but not limited to, ROM, RAM, flash memory, or the like. Examples of program instructions include both machine code, such as produced by a compiler, and files containing higher-level code that may be executed by the computer using an interpreter. The devices described above may be configured to act as one or more software modules in order to perform the operations of the embodiments, or vice versa.

The software may include a computer program, a piece of code, an instruction, or some combination thereof, to independently or uniformly instruct and/or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer readable recording mediums. Non-transitory computer readable recording media may exclude transitory signals.

While the embodiments are described with reference to drawings, it is to be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method of generating an image, performed by an electronic device, the method comprising:
obtaining an image sequence of a target scene and information about a first viewing angle, the image sequence comprising a plurality of images captured from the first viewing angle and having a first resolution;
generating a plurality of rays corresponding to a plurality of pixels of an image plane of the first viewing angle of the target scene;
determining a plurality of spatial points by sampling the plurality of rays;
generating a first rendered image of the image plane by rendering, using a first neural network, the plurality of spatial points, the first rendered image having the first resolution;
determining a reference image of the first rendered image from among the plurality of images of the image sequence; and
generating a second rendered image having a second resolution by upsampling, using a second neural network, the first rendered image based on the reference image.

2. The method of claim 1, wherein the obtaining of the image sequence of the target scene and the information about the first viewing angle comprises:
obtaining the image sequence by downsampling an original image of the target scene.

3. The method of claim 1, wherein the determining of the reference image comprises:
generating optical flow information of the target scene; and
determining, based on the optical flow information, the reference image from among the plurality of images of the image sequence.

4. The method of claim 3, wherein the determining of the reference image further comprises:
determining a first previous image from among one or more previous images of the first rendered image, based on forward optical flow information of the optical flow information;
determining a first following image from among one or more following images of the first rendered image, based on backward optical flow information of the optical flow information; and
determining at least one of the first previous image or the first following image as the reference image.

5. The method of claim 4, wherein the determining of the at least one of the first previous image or the first following image as the reference image comprises:
determining at least one similar region from the at least one of the first previous image or the first following image; and
determining the at least one of the first previous image or the first following image as the reference image based on performing a sliding window on the at least one similar region.

6. The method of claim 1, wherein the generating of the second rendered image comprises:
generating a first feature by extracting a first plurality of features from the first rendered image;
generating a second feature by extracting a second plurality of features from the reference image;
generating a third feature by fusing the first feature and the second feature;
generating a fourth feature by performing cascading residual processing on the third feature; and
generating the second rendered image by decoding the fourth feature.

7. The method of claim 1, further comprising:
updating the first neural network based on neural radiance fields (NeRF).

8. A non-transitory computer-readable storage medium storing instructions that, when executed by a processor, cause the processor to perform the method of claim 1.

9. An electronic device, comprising:
at least one processor; and
a memory storing instructions,
wherein the instructions are configured to, when individually or collectively executed by the at least one processor, cause the electronic device to:
obtain an image sequence of a target scene and information about a first viewing angle, the image sequence comprising a plurality of images captured from the first viewing angle and having a first resolution;
generate a plurality of rays corresponding to a plurality of pixels of an image plane of the first viewing angle of the target scene;
determine a plurality of spatial points by sampling the plurality of rays;
generate a first rendered image of the image plane by rendering, using a first neural network, the plurality of spatial points, the first rendered image having the first resolution;
determine a reference image of the first rendered image from among the plurality of images of the image sequence; and
generate a second rendered image having a second resolution by upsampling, using a second neural network, the first rendered image based on the reference image.

10. The electronic device of claim 9, wherein the instructions are configured to, when individually or collectively executed by the at least one processor, further cause the electronic device to:
obtain the image sequence by downsampling an original image of the target scene.

11. The electronic device of claim 9, wherein the instructions are configured to, when individually or collectively executed by the at least one processor, further cause the electronic device to:
generate optical flow information of the target scene; and
determine, based on the optical flow information, the reference image from among the plurality of images of the image sequence.

12. The electronic device of claim 11, wherein the instructions are configured to, when individually or collectively executed by the at least one processor, further cause the electronic device to:
determine a first previous image from among one or more previous images of the first rendered image, based on forward optical flow information of the optical flow information;
determine a first following image from among one or more following images of the first rendered image, based on backward optical flow information of the optical flow information; and
determine at least one of the first previous image or the first following image as the reference image.

13. The electronic device of claim 12, wherein the instructions are configured to, when individually or collectively executed by the at least one processor, further cause the electronic device to:
determine at least one similar region from the at least one of the first previous image or the first following image; and
determine the at least one of the first previous image or the first following image as the reference image based on performing a sliding window on the at least one similar region.

14. The electronic device of claim 9, wherein the instructions are configured to, when individually or collectively executed by the at least one processor, further cause the electronic device to:
generate a first feature by extracting a first plurality of features from the first rendered image;
generate a second feature by extracting a second plurality of features from the reference image;
generate a third feature by fusing the first feature and the second feature;
generate a fourth feature by performing cascading residual processing on the third feature; and
generate the second rendered image by decoding the fourth feature.

15. The electronic device of claim 9, wherein the instructions are configured to, when individually or collectively executed by the at least one processor, further cause the electronic device to:
update the first neural network based on neural radiance fields (NeRF).

16. A method of updating an image generation model, performed by an electronic device, the method comprising:
obtaining an image sequence of a target scene, the image sequence comprising a plurality of images having a first resolution;
generating, for a first image of the image sequence, a plurality of rays corresponding to a plurality of pixels of an image plane of a first viewing angle of the target scene;
determining a plurality of spatial points by sampling the plurality of rays;
generating a first rendered image of the image plane by rendering the plurality of spatial points using a first neural network of the image generation model, the first rendered image having the first resolution;
determining a reference image of at least one of the first image or the first rendered image;
generating a second rendered image having a second resolution by upsampling the first rendered image based on the reference image using a second neural network of the image generation model; and
updating the image generation model based on the second rendered image and the first image.

17. The method of claim 16, wherein the determining of the plurality of spatial points comprises:
determining the plurality of spatial points corresponding to a predetermined shape by sampling the plurality of rays according to the predetermined shape.

18. The method of claim 16, wherein the determining of the reference image comprises:
generating optical flow information of the target scene; and
determining, based on the optical flow information, the reference image from among the plurality of images of the image sequence.

19. The method of claim 16, wherein the generating of the second rendered image comprises:
generating the second rendered image by performing at least one of feature extraction, feature fusion, cascading residual processing, or feature decoding on the first rendered image and the reference image.

20. A non-transitory computer-readable storage medium storing instructions that, when executed by a processor, cause the processor to perform the method of claim 16.
